(19) United States
(12) Patent Application Publication
(10) Pub. No.: US 2004/0073479 A1
(43) Pub. Date: Apr. 15, 2004

(54) Method and apparatus for assessing an organization

(76) Inventor: Dean Walsh, St. Petersburg, FL (US)

Correspondence Address: CHALKER FLORES, LLP, 12700 PARK CENTRAL, STE. 455, DALLAS, TX, 75251, US

(21) Appl. No.: 10/303,536

(22) Filed: Nov. 23, 2002

Related U.S. Application Data
(60) Provisional application No. 60/418,537, filed on Oct. 15, 2002.

(51) Int. Cl. G06F 17/60

(52) U.S. Cl. 705/11

(57) ABSTRACT

The present invention provides a method and apparatus for assessing an organization using a competency model. The process includes determining which of one or more competencies specified in a competency model are satisfied by each person in the organization and associating the satisfied competencies with the person. The required competencies of each position specified in the competency model are then compared to the satisfied competencies of the person holding the position. A knowledge assessment is then provided based on the comparison of the required competencies to the satisfied competencies. This method can be implemented using a computer program with various code segments to implement the steps of the method.

### PRIORITY CLAIM

This patent application claims priority to U.S. provisional patent application serial No. 60/418,537 filed on Oct. 15, 2002.

### TECHNICAL FIELD OF THE INVENTION

The present invention relates generally to the field of business management and, more particularly, to a method, apparatus and system for assessing an organization.

### BACKGROUND OF THE INVENTION

Historically, competency-based programs and similar organizational initiatives have focused on the identification of capabilities and/or duties associated with specific jobs. In most cases, competency efforts have been used to supplement existing job-based information, such as job descriptions and job specifications. In fewer instances, competency programs have provided additional information for position oriented activities, such as compensation plans and pay banding. As a result, competency programs tend to remain with the Human Resources domain. Moreover, competencies themselves tend to be somewhat vague concepts, such as “attention to detail”, “bias for action” and “problem solving” capabilities.

These historical competency-based programs have numerous deficiencies. For example, competencies currently refer to imprecise and vague concepts that are inherently subjective, and rating scales that are general and imprecise (e.g., mastered, improving, satisfactory). Moreover, competencies are primarily used only to describe task or job-level activities. In addition, these competency programs do not distinguish between competency requirements for organizational positions, the capabilities of people holding the positions, and other people in the organization.

Accordingly, there is a need for a method and apparatus that can be used to assess an organization and overcome the limitations of previous systems by using a competency model to provide a knowledge assessment of the organization.

### SUMMARY OF THE INVENTION

The method and apparatus for assessing an organization in accordance with the present invention uses a competency model to provide a knowledge assessment of the organization. The knowledge assessment may include identifying knowledge requirements, capabilities, gaps and excesses within the organization. The competency model links competencies to strategic activities within the organization. Moreover, specific competency descriptions or definitions and scales are used that provide a better understanding and easier measurement of the competencies. As a result, the present invention is capable of distinguishing between competency requirements for organizational positions, the capabilities of people holding the positions, and other people in the organization. In addition, the present invention can be provided in an integrated competency management system.

The present invention provides a method for assessing an organization using a competency model. The process includes determining which of one or more competencies specified in a competency model are satisfied by each person in the organization and associating the satisfied competencies with the person. The required competencies of each position specified in the competency model are then compared to the satisfied competencies of the person holding the position. A knowledge assessment is then provided based on the comparison of the required competencies to the satisfied competencies. This method can be implemented using a computer program with various code segments to implement the steps of the method.

The present invention can also be implemented as an apparatus or system. The apparatus includes a processor, a data storage device communicably coupled to the processor, and an input/output device communicably coupled to the processor. A competency model is stored on or is resident in the data storage device. The processor determines which of one or more competencies specified in a competency model are satisfied by each person in the organization and associating the satisfied competencies with the person. The processor also compares the required competencies of the position specified in the competency model to the satisfied competencies of the person holding the position. A knowledge assessment is then provided on the input/output device based on the comparison of the required competencies to the satisfied competencies. The processor can also implement the other steps in the methods described above. Moreover, the processor can be one or more computer operating together in a network.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a diagram illustrating three-tiered model in accordance with the present invention;

FIG. 2A is a flow chart showing the process of using a competency model to improve the performance of an organization in accordance with one embodiment of the present invention;

FIG. 2B is a flow chart showing the process of creating a competency model for an organization in accordance with one embodiment of the present invention;

FIG. 3 is a flow chart showing the overall process of yet another embodiment in accordance with the present invention; and

FIG. 4 is a flow chart showing a competency management process of another embodiment in accordance with the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

The method and apparatus for assessing an organization in accordance with the present invention uses a competency model to provide a knowledge assessment of the organization. The knowledge assessment may include identifying knowledge requirements, capabilities, gaps and excesses within the organization. The competency model uses competencies to link strategic activities to job-level (operational) activities within the organization. Moreover, specific competency descriptions or definitions are used that provide a better understanding and easier measurement of the competencies. As a result, the present invention is capable of distinguishing between competency requirements for organizational positions, the capabilities of people holding the positions, and other people in the organization. In addition, the present invention can be provided in an integrated competency management system.

The present invention provides a means of defining competencies, their conceptual boundaries, and the elements that comprise them. Competencies are unique areas of knowledge or know-how (discipline) that are strategically important to the organization. Depending on the implementation, the present invention can provide one or more of the following benefits: (1) quantifying various degrees of expertise for each competency (individually and in aggregate); (2) identifying a single, enterprise-wide list (library) of strategically important competencies; (3) independently assigning competencies and required level of expertise to organizational positions and personnel; (4) identifying business critical (strategic) areas of knowledge (a vital organization resource); (5) converting strategic objectives and related work requirements to knowledge requirements; (6) linking strategic activities to work activities through the aggregation of competency requirements; (7) assessing organization (or any subset) capabilities through the measurement of peoples' capabilities; and (8) measuring/analyzing requirements and capabilities, and assesses gaps/excesses at many levels of aggregation (person or position to entire organization).

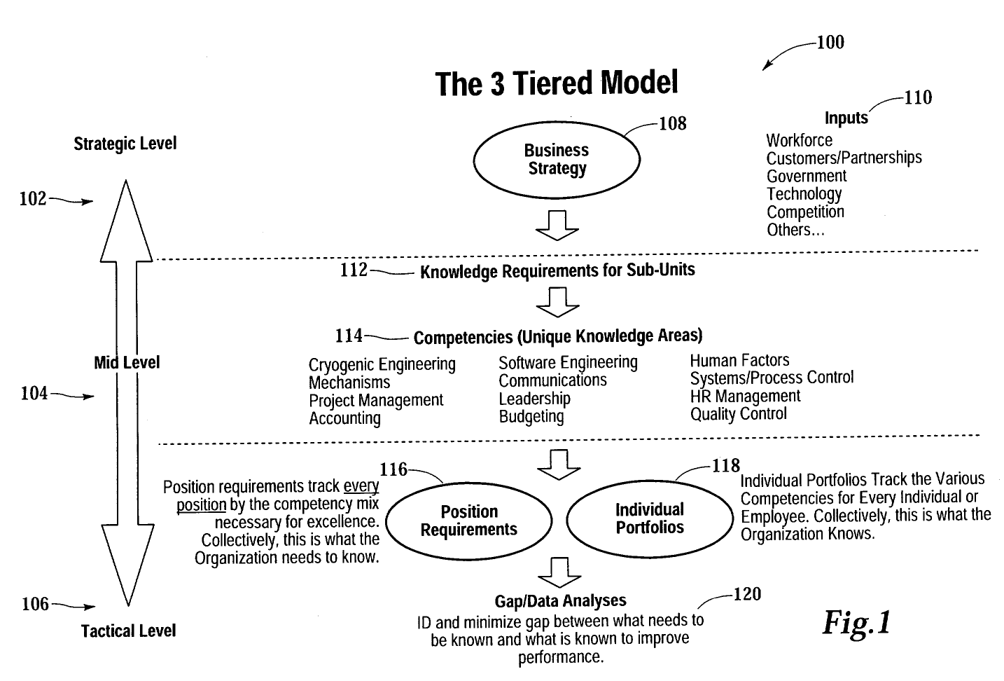

Now referring to FIG. 1, a diagram illustrating three-tiered model 100 in accordance with the present invention is shown. As will be described in more detail below, the competency model in accordance with the present invention contains one or more competencies that are assigned to each position to be modeled in the organization. The three tiers of the model 100 are the strategic level 102, the mid-level 104 and the tactical level 106. The strategic level 102 is where the business strategy or one or more strategic objectives 108 of the organization are identified. The organization can be a department, a company, a subsidiary, a region, a business unit, a facility or any other business entity or part thereof that is to be modeled. The strategic objectives 108 are developed using one or more inputs 110, which may include competition, customers, government, partnerships, technology or workforce. Work related requirements (no shown) can also be identified at this level 102.

The mid-level 104 is created by converting the strategic objectives 108 and related work requirements (not shown) into the one or more knowledge requirements 112 for sub-units to fulfill one or more strategic objectives 108 of the organization. One or more competencies 114 or unique knowledge areas are then identified to fulfill each knowledge requirement. The competencies 114 may include, for example, cryogenic engineering, mechanics, project engineering, accounting, software engineering, communication, leadership, budgeting, human factors, systems/process control, human resources management or quality control. Competencies 114 may also include advertising, computer hardware, computer software, education, engineering, information technology, legal, maintenance, marketing, mechanisms, organization management, public relations, sales or technical support. The competencies 114 actually used in a competency model will depend on the organization being modeled. Moreover, competencies 114 can also be identified that are critical to the organization. Competencies 114 may also be qualified using two or more degrees or levels of expertise. For example, a competency can be qualified into five degrees or levels: 0=base level and 1-4=increasing levels of expertise. In addition, the competencies 114 can be identified from a library of possible competencies.

At the tactical level 106, the position requirements 116 and individual portfolios 118 are developed. The position requirements 116 and individual portfolios 118 are then used in gap/data analyses 120 to improve the organization. The position requirements 116 track every position by the competency mix necessary for excellence. Collectively, this is what the organization needs to know to be successful. The position requirements 116 are created by determining which of the one or more competencies are required to satisfy a specified performance level for each position in the organization. The required competencies are then associated with the position. The specified performance level can be used to set up knowledge boundaries for the position, such as a minimum acceptable level and a preferred level.

The individual portfolios 118 track the various competencies for every person in the organization being modeled. The person can be an employee, independent contractor, consultant or other type of person involved in the organization. Collectively, this is what the organization knows. The individual portfolios 118 are created by determining which of one or more competencies specified in a competency model are satisfied by the person in the organization (and at an identifiable level of expertise) and associating the satisfied competencies with the person.

The gap/data analysis 120 identifies and seeks to provide a knowledge assessment of the organization. The knowledge assessment may include identifying knowledge requirements, capabilities, gaps and excesses within the organization. This knowledge assessment can then be used to improve the performance of the organization. The gap/data analysis 120 compares the required competencies of each position in the organization specified in the competency model to the satisfied competencies of the person holding the position. The gap/data analysis 120 can also be used to provide one or more recommended changes to the organization (or a subset) to minimize any knowledge gaps. The competency requirements of the organization can be aggregated to link strategic activities to work activities. The business strategy 108, inputs 110, knowledge requirements 112, the competencies 114, position requirements 116 and individual portfolios 118 can be periodically updated and the gap/data analysis 120 can be rerun.

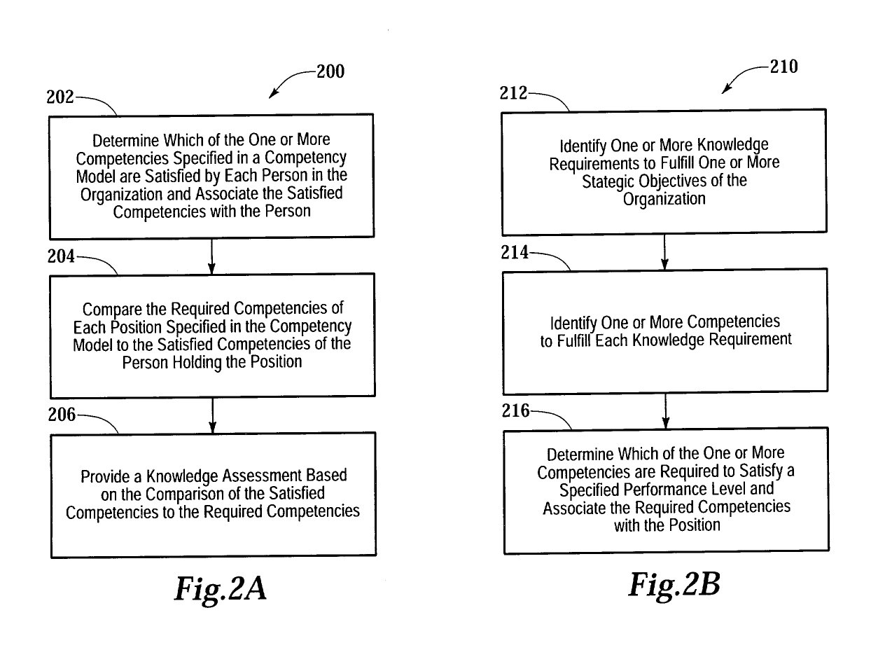

Referring now to FIG. 2A, a flow chart showing the process 200 of using a competency model to assess an organization in accordance with one embodiment of the present invention is shown. The process 200 determines which of the one or more competencies specified in a competency model are satisfied by each person in the organization and associates the satisfied competencies with the person in block 202. The required competencies of each position specified in the competency model are compared to the satisfied competencies of the person holding the position in block 204. Based on this comparison, the process provides a knowledge assessment of the organization in block 206.

Now referring to FIG. 2B, a flow chart showing the process 210 of creating a competency model for an organization in accordance with one embodiment of the present invention is shown. The process 210 identifies one or more knowledge requirements to fulfill one or more strategic objectives of the organization in block 212. One or more competencies are identified to fulfill each knowledge requirement in block 214. Thereafter, the process determines which of the one or more competencies are required to satisfy a specified performance level for each position in block 216. The required competencies are also associated with the position in block 216.

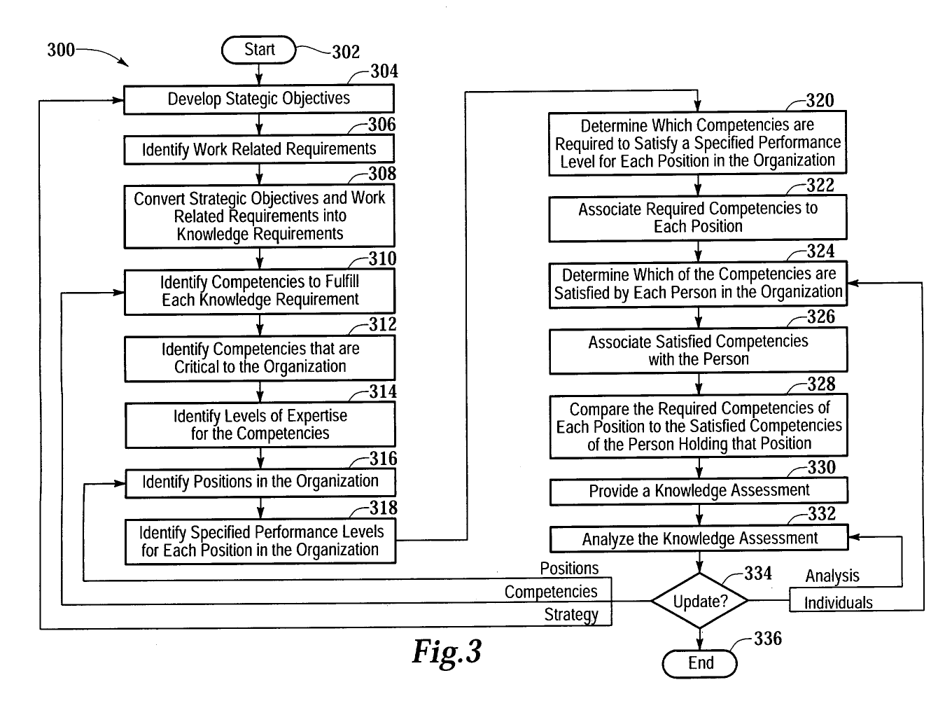

Referring now to FIG. 3, a flow chart showing the process 300 of yet another embodiment in accordance with the present invention is shown. The process 300 begins in block 302 and strategic objectives are developed in block 304. Work related requirements are identified in block 306. The strategic objectives and work related requirements are then converted into knowledge requirements in block 308. Competencies are identified to fulfill each knowledge requirement in block 310 and any competencies that are critical to the organization are identified in block 312. If the competencies have various levels of expertise, those levels of expertise are identified in block 314.

The positions within the organization being modeled and analyzed are identified in block 316. If the positions have various specified performance levels, those levels are identified in block 318. Thereafter, the process determines which competencies are required to satisfy a specified performance level for each position in the organization in block 320. The required competencies are associated with the position in block 322. The process then determines which of the competencies are satisfied by each person in the organization in block 324. The satisfied competencies are associated with the person in block 326.

Thereafter, the required competencies of each position are compared to the satisfied competencies of the person holding the position in block 328. Based on this comparison, the process provides a knowledge assessment of the organization in block 330. The knowledge assessment may include identifying knowledge requirements, capabilities, gaps and excesses within the organization. The knowledge assessment may include identifying knowledge requirements, capabilities, gaps and excesses within the organization. The knowledge assessment is analyzed in block 332. This analysis can include statistics or providing recommended changes the to organization, such as a reassignment of persons within the organization, an addition of persons to the organization or a removal of persons from the organization. If the data or analysis needs to be updated, as determined in decision block 334, the process loops back to block 304 if the strategy is to be updated, block 310 if the competencies are to be updated, block 316 if the positions are to be updated, block 324 if the individuals are to be updated, and block 332 if the analysis is to be updated. If the data or analysis does not need to be updated, the process ends in block 336. The process can also be rerun on a subset of any of the data. Moreover, the data can be analyzed to access the 20 organization's capabilities by measuring the satisfied competencies of the persons within the organization. The analysis may also be used to provide various statistics and other performance related information.

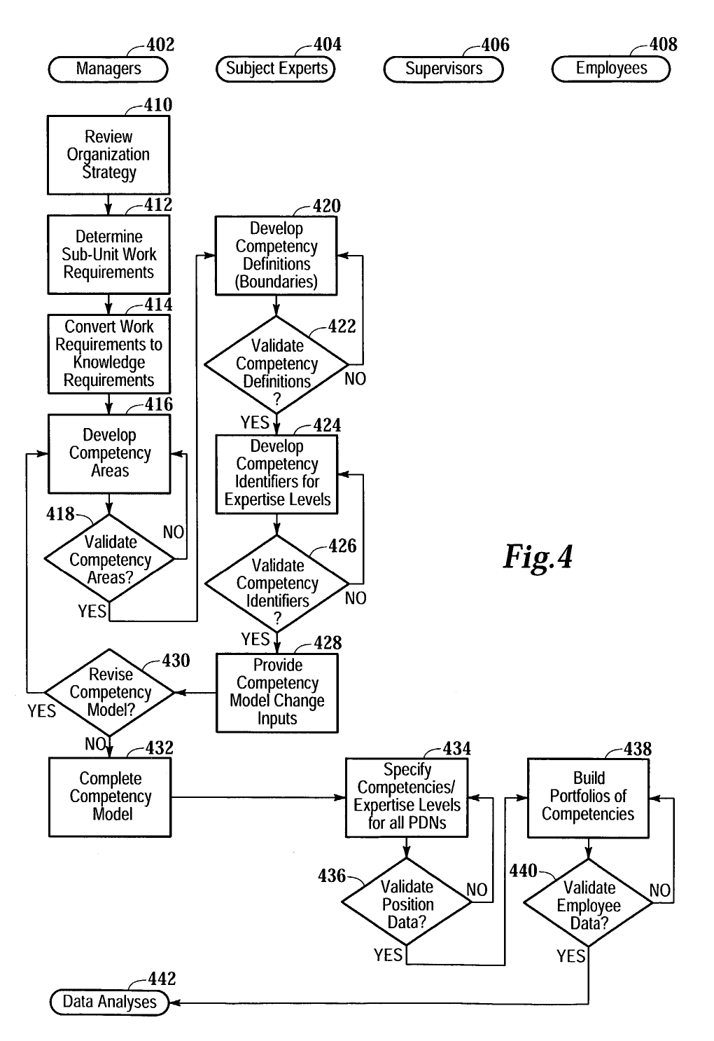

Now referring to FIG. 4, a flow chart showing a competency management process 400 of another embodiment in accordance with the present invention is shown. The competency management process 400 is performed at four levels of an organization to be analyzed: managers 402, subject experts 404, supervisors 406 and employees 408. Blocks 410-418, 430, 432 and 442 are preformed at the manager level 402. Blocks 420-428 are performed at the subject expert level 404. Blocks 434 and 436 are performed at the supervisor level 406. Blocks 438 and 440 are performed at the employee level 408.

The process 400 begins in block 410 where the organization strategy is reviewed. Sub-unit work requirements are determined in block 412 and those work requirements are converted to knowledge requirements in block 414. Competency areas are developed in block 416. If the competency areas are not valid, as determined in decision block 418, the competency areas are developed again in block 416. If, however, the competency areas are valid, competency definitions or boundaries are developed in block 420. If the competency definitions are not valid, as determined in decision block 422, the competency definitions are developed again in block 420. If, however, the competency definitions are valid, competency identifiers are developed for various expertise levels in block 426. Thereafter, competency model change inputs are provided in block 428. If the competency model needs to be revised, as determined in decision block 430, the process returns to block 416 where the competency areas are developed and the process repeats as previously described. If, however, the competency model does not need to be revised, the competency model is completed in block 432.

Competencies and expertise levels are specified for each position in the organization in block 434. If the position data is not valid, as determined in decision block 436, the position data is developed again in block 434. If, however, the position data is valid, portfolios of competencies are built for each employee or individual in the organization in block 438. If the employee data (satisfied competencies) is not valid, as determined in decision block 440, the employee data is built again in block 438. If, however, the employee data is valid, the data analysis process is performed in block 442.

The present invention can be implemented using a computer program with various code segments to implement the steps of the methods described above. In addition, the computer program can be used to provide any of the following functions: (1) measure competency requirements and available capabilities of an organization or some subset; (2) provide detailed on-line reports pertaining to competency gaps and excesses, position and employee statistics, and system status; (3) provide on-line administrative capabilities to monitor and modify competency descriptions; (4) provide on-line data validation capabilities (work-flows) for competency requirements and capabilities; (5) provide search capabilities for locating employees or positions by competency mix or text match; and (6) web-based application requiring only browser software (client) and existing intranet applications (server).

The present invention can also be implemented as an apparatus or system. The apparatus includes a processor, a data storage device communicably coupled to the processor, and an input/output device communicably coupled to the processor. A competency model is stored on or is resident in the data storage device. The processor determines which of one or more competencies specified in a competency model are satisfied by each person in the organization and associating the satisfied competencies with the person. The processor also compares the required competencies of the position specified in the competency model to the satisfied competencies of the person holding the position. The processor then provides a knowledge assessment of the organization. The knowledge assessment may include identifying knowledge requirements, capabilities, gaps and excesses within the organization. The processor can also implement the other steps in the methods described above. Moreover, the processor can be one or more computer operating together in a network.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth herein is not intended to be exhaustive or to limit the invention to the precise form disclosed. Many modifications and variations are possible in light of the above teaching without departing from the spirit and scope of the following claims.

What is claimed is:

1. A method for assessing an organization comprising the steps of:
(a) for each person in the organization, determining which of one or more competencies specified in a competency model are satisfied by the person and associating the satisfied competencies with the person;
(b) for each position in the organization, comparing the required competencies of the position specified in the competency model to the satisfied competencies of the person holding the position; and
(c) providing a knowledge assessment based on the comparison of step (b).

2. The method as recited in claim 1, wherein the knowledge assessment includes an assessment of the organization's capabilities by measuring the satisfied competencies of the persons within the organization.

3. The method as recited in claim 1, further comprising the step of identifying competencies that are critical to the organization.

4. The method as recited in claim 1, further comprising the step of qualifying two or more degrees of expertise for each competency.

5. The method as recited in claim 1, further comprising the steps of:
periodically updating the competency model and the satisfied competencies; and
repeating steps (b) and (c).

6. The method as recited in claim 1, wherein the comparison of step (b) is performed on a subset of the persons and the positions.

7. The method as recited in claim 1, wherein the comparison of step (b) is performed on a subset of the competency model.

8. The method as recited in claim 1, wherein the comparison of step (b) is performed on a subset of the organization.

9. The method as recited in claim 1, wherein the organization is a department, a company, a subsidiary, a region, a business unit or a facility.

10. The method as recited in claim 1, wherein the competencies include accounting, advertising, budgeting, communications, computer hardware, computer software, education, engineering, human factors, human resources, information technology, leadership, legal, maintenance, marketing, mechanisms, organization management, project management, public relations, quality control, sales, technical support or systems/process control.

11. The method as recited in claim 1, wherein the knowledge assessment includes knowledge requirements, capabilities, gaps or excesses.

12. The method as recited in claim 1, further comprising the step of providing one or more recommended changes to the organization based on the knowledge assessment.

13. The method as recited in claim 12, wherein the one or more recommended changes include a reassignment of persons within the organization, an addition of persons to organization or a removal of persons from organization.

14. The method as recited in claim 1, further comprising the step of developing the competency model for the organization, the competency model containing the one or more competencies and the one or more required competencies for each position to be modeled in the organization.

15. The method as recited in claim 14, wherein the step of developing the competency model for the organization comprises the steps of:
identifying one or more knowledge requirements to fulfill one or more strategic objectives of the organization;
identifying one or more competencies to fulfill each knowledge requirement; and
for each position in the organization, determining which of the one or more competencies are required to satisfy a specified performance level and associating the required competencies with the position.

16. The method as recited in claim 15, further comprising the steps of:
periodically updating the knowledge requirements, the competencies, the required competencies, the satisfied competencies, and the performance levels; and
repeating steps (b) and (c).

17. The method as recited in claim 15, wherein the one or more competencies are identified from a library of possible competencies.

18. The method as recited in claim 15, wherein the strategic objectives are developed using one or more inputs, the input including competition, customers, government, partnerships, technology or workforce.

19. The method as recited in claim 15, wherein the specified performance level is a minimum acceptable level.

20. The method as recited in claim 15, wherein the specified performance level is a preferred level.

21. The method as recited in claim 15, wherein the step of identifying one or more knowledge requirements to fulfill one or more strategic objectives of the organization comprises the steps of:
identifying the one or more strategic objectives of the organization and one or more related work requirements; and
converting the strategic objectives and related work requirements into the one or more knowledge requirements.

22. The method as recited in claim 21, further comprising the step of linking strategic activities to work activities through the aggregation of competency requirements.

23. A computer program embodied on a computer readable medium for assessing an organization comprising:
a code segment for determining which of one or more competencies specified in a competency model are satisfied by for each person in the organization and associating the satisfied competencies with the person;
a code segment for comparing the required competencies of each position specified in the competency model to the satisfied competencies of the person holding the position; and
a code segment for providing a knowledge assessment based on the comparison of the required competencies to the satisfied competencies.

24. The computer program as recited in claim 23, wherein the knowledge assessment includes an assessment of the organization's capabilities by measuring the satisfied competencies of the persons within the organization.

25. The computer program as recited in claim 23, further comprising a code segment for identifying competencies that are critical to the organization.

26. The computer program as recited in claim 23, further comprising a code segment for qualifying two or more degrees of expertise for each competency.

27. The computer program as recited in claim 23, further comprising:
a code segment for periodically updating the competency model and the satisfied competencies; and
a code segment for repeating the comparison of the required competencies to the satisfied competencies, the determination of the knowledge gap and providing the recommended changes.

28. The computer program as recited in claim 23, wherein the comparison is performed on a subset of the persons and the positions.

29. The computer program as recited in claim 23, wherein the comparison is performed on a subset of the competency model.

30. The computer program as recited in claim 23, wherein the comparison is performed on a subset of the organization.

31. The computer program as recited in claim 23, wherein the organization is a department, a company, a subsidiary, a region, a business unit or a facility.

32. The computer program as recited in claim 23, wherein the competencies include accounting, advertising, budgeting, communications, computer hardware, computer software, education, engineering, human factors, human resources, information technology, leadership, legal, maintenance, marketing, mechanisms, organization management, project management, public relations, quality control, sales, technical support or systems/process control.

33. The computer program as recited in claim 23, wherein the knowledge assessment includes knowledge requirements, capabilities, gaps or excesses.

34. The computer program as recited in claim 23, further comprising the step of providing one or more recommended changes to the organization based on the knowledge assessment.

35. The computer program as recited in claim 34, wherein the one or more recommended changes include a reassignment of persons within the organization, an addition of persons to organization or a removal of persons from organization.

36. The computer program as recited in claim 23, further comprising a code segment for developing the competency model for the organization, the competency model containing the one or more competencies and the one or more required competencies for each position to be modeled in the organization.

37. The computer program as recited in claim 36, wherein the code segment for developing the competency model for the organization comprises:
a code segment for identifying one or more knowledge requirements to fulfill one or more strategic objectives of the organization;
a code segment for identifying one or more competencies to fulfill each knowledge requirement; and
a code segment for determining which of the one or more competencies are required to satisfy a specified performance level for each position in the organization and associating the required competencies with the position.

38. The computer program as recited in claim 37, further comprising:
a code segment for periodically updating the knowledge requirements, the competencies, the required competencies, the satisfied competencies, and the performance levels; and
a code segment for repeating the comparison of the required competencies to the satisfied competencies, the determination of the knowledge gap and providing the recommended changes.

39. The computer program as recited in claim 37, wherein the one or more competencies are identified from a library of possible competencies.

40. The computer program as recited in claim 37, wherein the strategic objectives are developed using one or more inputs, the input including competition, customers, government, partnerships, technology or workforce.

41. The computer program as recited in claim 37, wherein the specified performance level is a minimum acceptable level.

42. The computer program as recited in claim 37, wherein the specified performance level is a preferred level.

43. The computer program as recited in claim 37, wherein the code segment for identifying one or more knowledge requirements to fulfill one or more strategic objectives of the organization comprises:
a code segment for identifying the one or more strategic objectives of the organization and one or more related work requirements; and
a code segment for converting the strategic objectives and related work requirements into the one or more knowledge requirements.

44. The computer program as recited in claim 43, further comprising a code segment for linking strategic activities to work activities through the aggregation of competency requirements.

45. An apparatus for assessing an organization comprising the steps of:
a processor;
a data storage device communicably coupled to the processor, the data storage device having a competency model;
an input/output device communicably coupled to the processor; and
the processor determining which of one or more competencies specified in a competency model are satisfied by each person in the organization and associating the satisfied competencies with the person, comparing the required competencies of the position specified in the competency model to the satisfied competencies of the person holding the position, and providing a knowledge assessment on the input/output device based on the comparison of the required competencies to the satisfied competencies.

46. The apparatus as recited in claim 45, wherein the knowledge assessment includes an assessment of the organization's capabilities by measuring the satisfied competencies of the 3 persons within the organization.

47. The apparatus as recited in claim 45, wherein the processor identifies competencies 2 that are critical to the organization.

48. The apparatus as recited in claim 45, wherein the processor qualifies two or more degrees of expertise for each competency.

49. The apparatus as recited in claim 45, wherein the processor periodically updates the competency model and the satisfied competencies, and repeats the comparison of the required competencies to the satisfied competencies, the determination of the knowledge gap and providing the recommended changes.

50. The apparatus as recited in claim 45, wherein the comparison is performed on a subset of the persons and the positions.

51. The apparatus as recited in claim 45, wherein the comparison is performed on a subset of the competency model.

52. The apparatus as recited in claim 45, wherein the comparison is performed on a subset of the organization.

53. The apparatus as recited in claim 45, wherein the organization is a department, a company, a subsidiary, a region, a business unit or a facility.

54. The apparatus as recited in claim 45, wherein the competencies include accounting, advertising, budgeting, communications, computer hardware, computer software, education, engineering, human factors, human resources, information technology, leadership, legal, maintenance, marketing, mechanisms, organization management, project management, public relations, quality control, sales, technical support or systems/process control.

55. The apparatus as recited in claim 45, wherein the knowledge assessment includes knowledge requirements, capabilities, gaps or excesses.

56. The apparatus as recited in claim 45, further comprising the step of providing one or more recommended changes to the organization based on the knowledge assessment.

57. The apparatus as recited in claim 56, wherein the one or more recommended changes include a reassignment of persons within the organization, an addition of persons to organization or a removal of persons from organization.

58. The apparatus as recited in claim 45, wherein the processor develops the competency model for the organization, the competency model containing the one or more competencies and the one or more required competencies for each position to be modeled in the organization.

59. The apparatus as recited in claim 58, wherein the processor develops the competency model for the organization by identifying one or more knowledge requirements to fulfill one or more strategic objectives of the organization, identifying one or more competencies to fulfill each knowledge requirement, and determining which of the one or more competencies are required to satisfy a specified performance level for each position in the organization and associating the required competencies with the position.

60. The apparatus as recited in claim 59, wherein the processor periodically updates the knowledge requirements, the competencies, the required competencies, the satisfied competencies, and the performance levels, and repeats the comparison of the required competencies to the satisfied competencies, the determination of the knowledge gap and providing the recommended changes.

61. The apparatus as recited in claim 59, wherein the one or more competencies are identified from a library of possible competencies.

62. The apparatus as recited in claim 59, wherein the strategic objectives are developed using one or more inputs, the input including competition, customers, government, partnerships, technology or workforce.

63. The apparatus as recited in claim 59, wherein the specified performance level is a minimum acceptable level.

64. The apparatus as recited in claim 59, wherein the specified performance level is a preferred level.

65. The apparatus as recited in claim 59, wherein the processor identifies one or more knowledge requirements to fulfill one or more strategic objectives of the organization by identifying the one or more strategic objectives of the organization and one or more related work requirements, and converts the strategic objectives and related work requirements into the one or more knowledge requirements.

66. The apparatus as recited in claim 65, wherein the processor links strategic activities to work activities through the aggregation of competency requirements.
